(19) United States
(12) Patent Application Publication
(10) Pub. No.: US 2012/0210059 A1
(43) Pub. Date: Aug. 16, 2012

(54) CASCADED RAID CONTROLLER

(75) Inventors: Bradley Justice, Richmond, CA (US); John W. Wolff, Cortland, NY (US)

(73) Assignee: Ithaca Technologies, LLC, Cortland, NY (US)

(21) Appl. No.: 13/025,649

(22) Filed: Feb. 11, 2011

(51) Int. Cl. G06F 12/00

(52) U.S. Cl. 711/114; 711/E12.001

(57) ABSTRACT

A cascaded RAID controller includes a master RAID 1 controller having a control level and M slave RAID 1 controllers, where M is an integer greater than or equal to 1. Each of the M+1 RAID 1 controllers is configured respectively to have three ports, including a primary port configured to communicate bi-directionally with computer hardware having a higher control level than that of the respective one of the M+1 RAID 1 controllers and including two secondary ports. The cascaded RAID controller is configured to provide connections to a total of M+2 memory devices, and configured to record the same information on each of the M+2 memory devices to create M+2 identical copies of the information. A process for initializing a cascaded RAID controller is also described.

### FIELD OF THE INVENTION

The invention relates to a cascaded RAID controller in general and particularly to a cascaded RAID controller that employs a plurality of RAID 1 controllers.

### BACKGROUND OF THE INVENTION

Computer hardware that writes data simultaneously to two storage devices is available, for example as RAID 1 arrays. Such hardware devices are typically implemented as single chip based solutions which create the RAID 1 array. When connected via a data bus, such as a USB, FireWire or eSATA connection, the RAID 1 chip controller presents a single virtual drive to a host. Data is written by the host computer to the virtual drive. Data is typically written to each of the two physical drives via a SATA data connection. Similarly, data read by the host computer from the virtual drive, is read via a SATA connection from the physical drives. To the host computer, it appears as if it is writing to a single storage device. The RAID 1 controller writes complete and exact copies of the data to both of the two connected storage devices. The two copies are created at substantially the same speed as a single copy.

There is a need for hardware devices that can simultaneously write the same data to three or more memory devices.

### SUMMARY OF THE INVENTION

According to one aspect, the invention features a cascaded RAID controller, which includes a master RAID 1 controller having a control level and M slave RAID 1 controllers each having a lower control level than the control level of the master RAID 1 controller, where M is an integer greater than or equal to 1. Each of the M+1 RAID 1 controllers is configured respectively to have three ports, including a primary port configured to communicate bi-directionally with computer hardware having a higher control level than that of the respective one of the M+1 RAID 1 controllers and including two secondary ports. Each secondary port is configured to communicate bi-directionally with computer hardware having a lower control level than that of the respective one of the M+1 RAID 1 controllers. Each one of the M+1 RAID 1 controllers has a direct communication connection to at least one other RAID 1 controller of the M+1 RAID 1 controllers. The master RAID 1 controller is configured to be connected to a host computer having a highest control level via the primary port of the master RAID 1 controller. Each of the otherwise unconnected secondary ports of the M+1 RAID 1 controllers is configured to be communicatively connected bi-directionally to a memory device configured to record information. At least one of the M slave controllers is configured to determine whether two memory devices connected to the secondary ports of the at least one of the M slave controllers are configured as a duplicate RAID 1 memory. The master RAID 1 controller is configured to determine whether the two memory devices are connected to the secondary ports of the at least one of the M slave controllers and another memory device is connected to a respective one of the secondary ports of another of the M+1 RAID 1 controllers are configured as a triplicate RAID 1 memory. The cascaded RAID controller is configured to provide connections to a total of M+2 memory devices, and configured to record the same information on each of the M+2 memory devices to create M+2 identical copies of the information.

In one embodiment, the primary port of the master RAID 1 controller is configured to communicate bi-directionally with computer hardware includes an eSATA data connection.

In another embodiment, the primary port of the master RAID 1 controller is configured to communicate bi-directionally with computer hardware includes a FireWire data connection.

In yet another embodiment, the primary port of the master RAID 1 controller is configured to communicate bi-directionally with computer hardware includes a USB data connection.

In yet another embodiment, the direct communication connection includes a selected one of a plurality of general purpose I/O (GPIO) lines, SATA, and eSATA.

In yet another embodiment, a RAID 1 controller at a level L communicates to a RAID 1 controller at a level L−1 a status indicative of whether a state store record is found on either of its own the two secondary ports via the direct communication connection.

In yet another embodiment, M=1 and the cascaded RAID controller is configured as a triplicator.

According to another aspect, the invention features a process for initializing a cascaded RAID controller including the steps of: providing a cascaded RAID controller including a master RAID 1 controller having a control level and M slave RAID 1 controllers each having a lower control level than the control level of the master RAID 1 controller, where M is an integer greater than or equal to 1, each one of the M+1 RAID 1 controllers having a direct communication connection to at least one other RAID 1 controller of the M+1 RAID 1 controllers; running an initialization process simultaneously on the M+1 RAID 1 controllers to check for a valid RAID 1 array; communicating a status of a valid RAID 1 array from each of the M+1 RAID 1 controllers at a level L to a RAID 1 controller at a level L−1; loading each of the RAID 1 controllers when all RAID 1 controllers at one or more levels below the level L of each RAID 1 controller have indicated a presence of a valid RAID 1 array; and presenting a virtual memory device at a primary port of the master RAID 1 controller.

In one embodiment, the step of presenting a virtual memory device includes the step of presenting a virtual memory device at a primary port of the master RAID 1 controller, wherein the virtual memory device includes a total of up to M+2 memory devices.

In another embodiment, the step of running an initialization process simultaneously on the M+1 RAID 1 controllers includes checking for a presence of and reading a state store record on both secondary ports of each of the M+1 RAID 1 controllers.

The foregoing and other objects, aspects, features, and advantages of the invention will become more apparent from the following description and from the claims.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

FIG. 1A shows a block diagram of one embodiment of a cascaded RAID controller architecture according to the invention.

FIG. 1B shows a block diagram of one exemplary embodiment of a cascaded RAID triplicator apparatus according to the invention.

FIG. 2 shows a block diagram of another embodiment of a cascaded RAID controller architecture according to the invention.

FIG. 3A shows a flow chart of one embodiment of a process control for a level L of a cascaded RAID apparatus having one slave at level L+1.

FIG. 3B shows a flow chart of one embodiment of a process control for a level L of a cascaded RAID apparatus having two slaves at level L+1.

FIG. 3C shows a flow chart of another embodiment of a process control for a slave level L of a cascaded RAID apparatus.

FIG. 4 shows a hardware block diagram of one exemplary triplicator embodiment.

FIG. 5 shows a table of the sixteen possible memory device and/or slave configurations at a level 3 for the exemplary cascaded RAID apparatus of FIG. 2.

### DETAILED DESCRIPTION

The apparatus of the invention comprises a master RAID 1 controller having a control level and M slave RAID 1 controllers each having a lower control level than the control level of the master RAID 1 controller. M is an integer greater than or equal to 1. Each of the M+1 RAID 1 controllers is configured respectively to have three ports. The ports include a primary port and two secondary ports. The primary port is configured to communicate bi-directionally with computer hardware having a higher control level than that of the respective one of the M+1 RAID 1 controllers. Each secondary port is configured to communicate bi-directionally with computer hardware having a lower control level than that of the respective one of the M+1 RAID 1 controllers. The computer hardware at the next lower level can be a memory device, such as a hard drive, a solid state drive or another equivalent memory device, or it can be another slave RAID 1 controller. The two ports of a slave controller at a lowest level, termed level N where N is an integer greater than or equal to 2, are each connected to memory devices.

### Cascaded Raid Apparatus Architecture

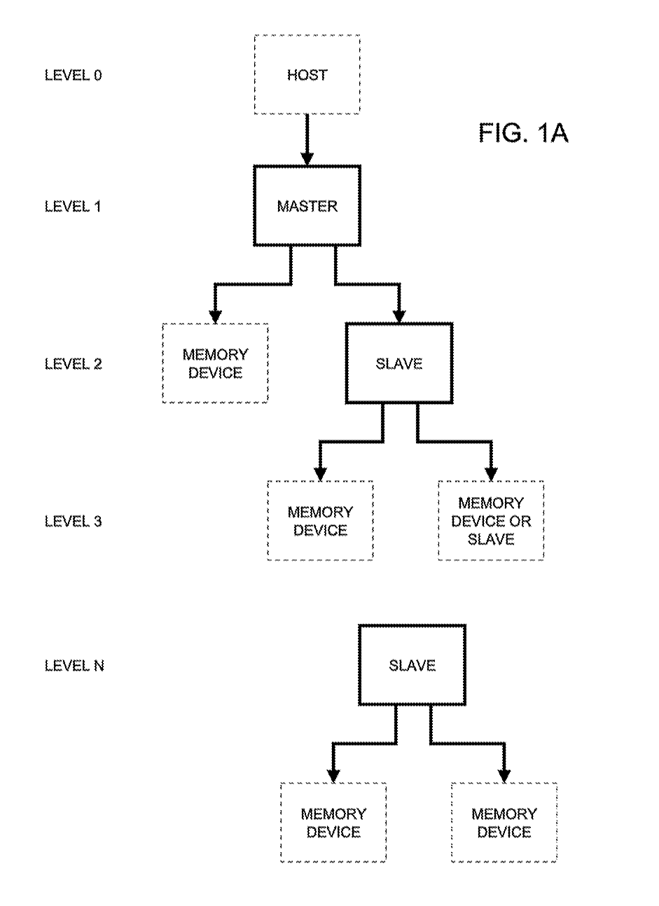

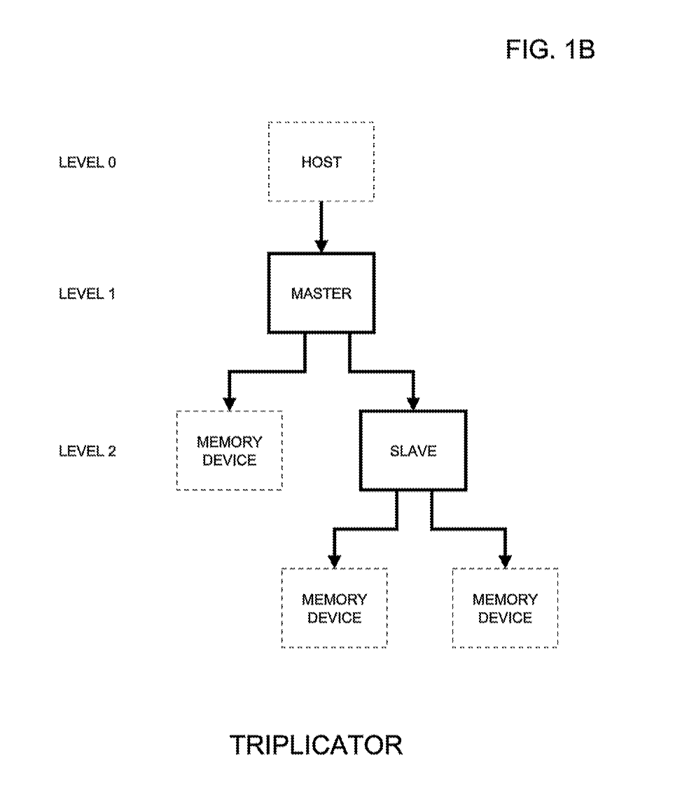

FIG. 1A shows a block diagram of one embodiment of a cascaded RAID controller architecture. The boxes in dotted lines represent components which can be connected to ports of a cascaded RAID controller. Components shown in dotted lines are not claimed elements, but merely show the interaction of the invention with those unclaimed elements by way of explanation. A host (level 0), typically a computer, connects to a master RAID 1 controller via the primary port of the master RAID 1 controller. The master RAID 1 controller (level 1) has two secondary ports. At a level below the master RAID 1 controller (level 2), one secondary port is connected to a memory device and the other secondary port is connected to a slave RAID 1 controller. The slave RAID 1 controller at level 2 also has two secondary ports which can be connected respectively to one memory device and one slave RAID 1 controller. Level 1 represents the master level of control and level 2, a first slave level of control, followed by additional levels up to level N. FIG. 1B shows a block diagram of one exemplary embodiment of a cascaded RAID “triplicator” controller having two levels. At level 2, there is one memory device controlled by the master RAID 1 controller and one slave RAID 1 controller. Below level 2, the triplicator embodiment is terminated with two memory devices connected to the secondary ports of the level 2 slave RAID 1 controller.

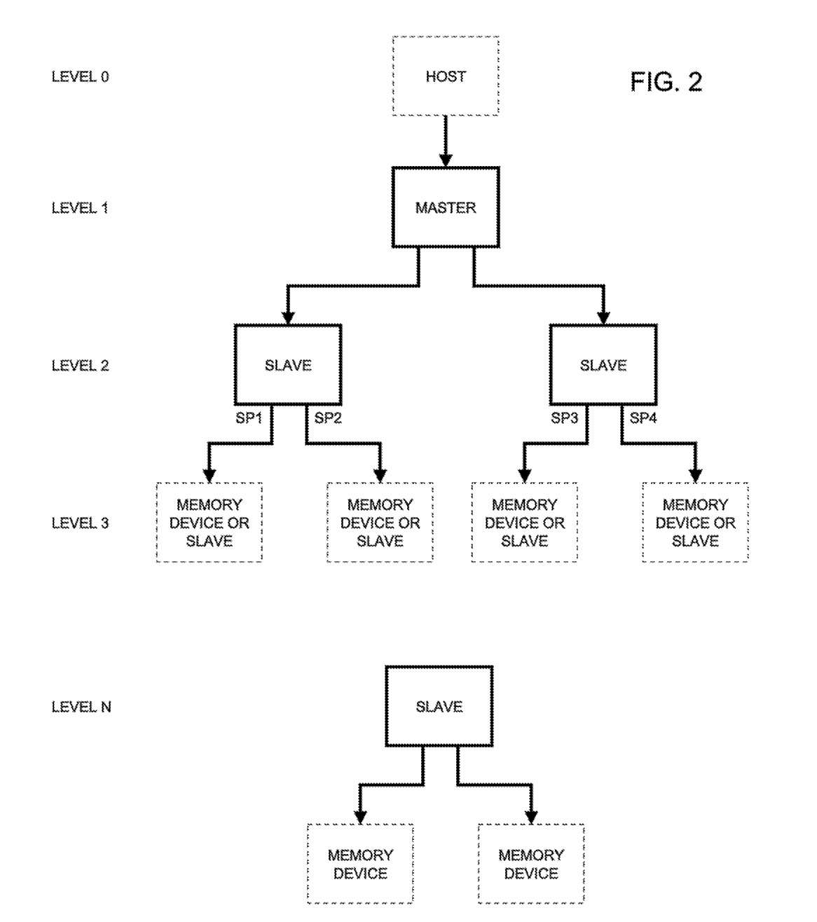

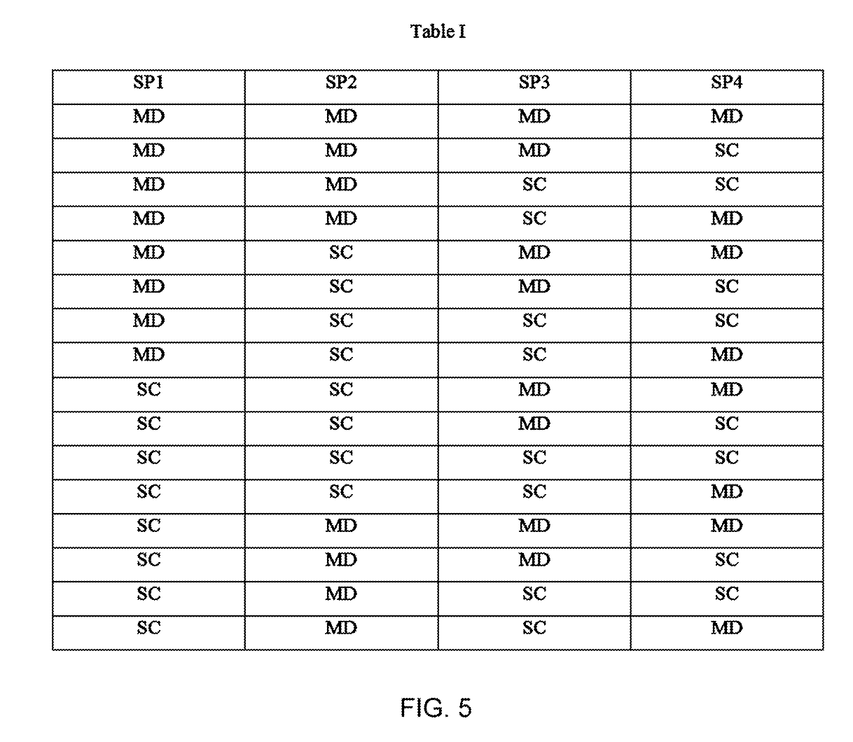

FIG. 2 shows a block diagram of another embodiment of a cascaded RAID controller architecture. In the embodiments of a cascaded RAID controller according to FIG. 2, there is a master RAID 1 controller at level 1. At level 2, two slave RAID 1 controllers are each connected to the secondary ports of the master RAID 1 controller. Each of the two slave RAID 1 controllers of level 2 can have either a slave RAID 1 controller or a memory device connected to each of the RAID 1 secondary ports. Since there are a total of four secondary ports at level 2, each of which can be terminated with either of two types of devices (a memory device, denoted as MD or a slave controller, denoted as SC), there are in principle 16 (=2⁴) different configurations of such a controller having only N=3. The sixteen possible configurations are listed in the Table I of FIG. 5. We list the secondary ports of the level 2 slave controllers as SP1, SP2, SP3 and SP4, from left to right in FIG. 2. If the same type of memory device (MD) and the same type of slave controller (SC) are used throughout, the number of distinct configurations may be only 8 in number. If in addition, the two ports of each slave controller are considered to be equivalent (e.g., SP1 and SP2 are interchangeable, SP3 and SP4 are interchangeable), the number of discrete configurations may be 4 in number.

Each master RAID 1 controller and each of the M slave RAID 1 controllers has two secondary ports. Therefore a cascaded RAID controller comprising one master and M (where M>1) slave controllers (total M+1 controllers) has a total number of 2M+2 secondary ports. Since each of the M slave RAID 1 controllers takes up one secondary port from the level above, a cascaded RAID controller devotes M secondary ports for connecting the M slave controllers via each of their M primary ports. This leaves (2M+2)−M=M+2 secondary ports for drives. Since M>1 for a cascaded RAID controller as described, M+2>3. Therefore, embodiments of a cascaded RAID controller generally have secondary ports which can support 3 or more memory devices.

### Cascaded Raid Apparatus Process

According to the prior art, each RAID 1 controller is taught to be used as a single non-cascaded array. In fact, if an attempt is made to cascade RAID 1 arrays, without further improvement, the existing data on one or more memory devices can be overwritten at turn-on. Without the inventive process, a cascaded array having 3 or more memory devices cannot properly discover all of the memory devices at turn-on. Without this “discovery” or initialization process, one or more of the layers of such a cascaded RAID apparatus always creates one or more new arrays during initialization. A new array created at initialization results in the destruction of any existing data on the memory devices at and below that level. We came to a realization that the RAID 1 controller firmware of the prior art can be modified as described in detail hereinbelow, to add functionality which makes cascaded RAID arrays having 3 or more memory devices possible.

Information regarding a RAID 1 memory device array state is generally stored on the drives that comprise that array. For example, if two independent RAID 1 controllers are cascaded according to the invention, the state of the two arrays is layered one on top of the other (e.g., level 1 and level 2, FIG. 1A). Without modification, each RAID 1 controller is only “aware” of the layer that it manages. Additional information should be shared between the M controllers in order to properly manage a cascaded RAID array. To successfully implement a cascaded RAID controller architecture, the initialization state of the RAID 1 device arrays at each level can be determined.

In the description which follows, we refer to a “valid” two drive array and a “valid” single drive array. In the context of the cascaded RAID controller, valid refers to the status of a record of initialization, called “state information” or the “state store” or the “state store record”. The state store information, typically stored on a (physical) memory device, can include information, such as generational information, information about what sectors are in use, and other typically proprietary information for a commercial RAID controller chip or chip-set.

At each level, there are three possible states for the RAID 1 component arrays: 1) a RAID 1 array initialized as a valid two memory device RAID 1 array, 2) a RAID 1 array initialized as a valid single memory device array, and 3) no valid RAID 1 array. The state store record provides information about the RAID 1 array configuration at each level. For example, the state stores which are represented to the master level 1 controller, in the embodiment of FIG. 1A, represent a RAID 1 array status of one connected slave and one connected memory device (e.g., a physical drive). The state stores which are represented to the master level 1 controller, in the embodiment of FIG. 2, represent a RAID 1 array status of two virtual memory devices (two RAID 1 controllers at level 2).

Upon activation of a cascaded RAID controller, each of the master and slave RAID 1 controllers examine state store records revealing what is attached their two secondary ports (e.g., a slave or a memory device). When a RAID 1 controller at level L has slave controllers at the next lower level (L+1), the actual state record is typically stored on the memory devices under those virtual slaves. In this case of one or two slave RAID 1 controller at level L+1, some or all of the state store information which is eventually conveyed from the level L+1 RAID 1 controller to the level L RAID 1 controller was originally read by the level L+1 RAID 1 controller from one or more slaves or memory devices connected to the secondary ports of the level L+1 RAID 1 controller. While state store records can be “conveyed up the line” by a RAID 1 controller during the cascaded RAID controller initialization process, the state store records are typically only present as records on a physical memory device.

### Discovery Process

As described hereinabove, RAID 1 arrays cannot be cascaded without modification. Without process modification, some levels of the cascaded RAID controller would not be properly initialized, resulting in overwritten data. The inventive method uses a discovery process to solve the problem by correctly initializing each RAID 1 level of the cascaded RAID controller. Typically, the cascaded RAID controller initializes from the lowest or “N” level upward. However, at each level of initialization, there can also be a signal sent to the highest master level 0, indicating that initialization is still taking place and that the cascaded RAID controller is not yet ready to be used as a virtual drive. As each level reports a proper RAID 1 array or properly initializes its local RAID 1 array or arrays, the initialization process moves to the next level, typically the N−1 level, moving towards the master level 1.

When turned on, a RAID 1 controller looks for a state store record on both of its secondary ports. The first question then is: Can a state store record be read from what is connected to a secondary port? If the RAID 1 controller cannot find a state store record, then an uninitialized memory device (or virtual memory device, typically another RAID 1 controller) is present, or no memory device (or virtual memory device) is connected to that secondary port.

The second question asked by a RAID 1 controller is: Is the information in a found state record consistent? Exemplary information found in the state store record, which should be consistent with other state stores of both the RAID 1 level and the cascaded RAID controller, include an indication that all memory devices are part of the same RAID 1 array and that they all have the same generational information. Generational information indicates that data was last written to the memory device at about the same time as when data was written to the other memory device in the RAID 1 array, or to other memory devices throughout a cascaded RAID array. If, for example, a memory device was taken from one cascaded RAID controller apparatus and placed in another cascaded RAID controller apparatus, the RAID 1 array generational value would be different. If a memory device is found to have inconsistent generational information, that memory device causes a “not valid” indication. Mismatched generational records are taken as not valid since the generational information of the memory devices in any previously properly working cascaded RAID controller should be the same.

Following discovery of any memory device having a state store record that causes an invalid indication (e.g., inconsistent generational information), a cascaded RAID controller can prompt a user as to whether it should proceed with initialization, or if the user would prefer to remove or replace that memory device. The prompt can notify the user that some action should be taken to correct a problem that caused the invalid indication, for example reconnect an improperly connected drive. Alternately, the prompt can help a user to save data on the drive which otherwise would likely be made inaccessible or overwritten if the initialization were to proceed. In a case where a previously used memory device is being intentionally re-cycled, initialization can proceed without concern. The first time a memory device is found in a RAID 1 array, it is never valid, since it has not yet had a store state record written to it.

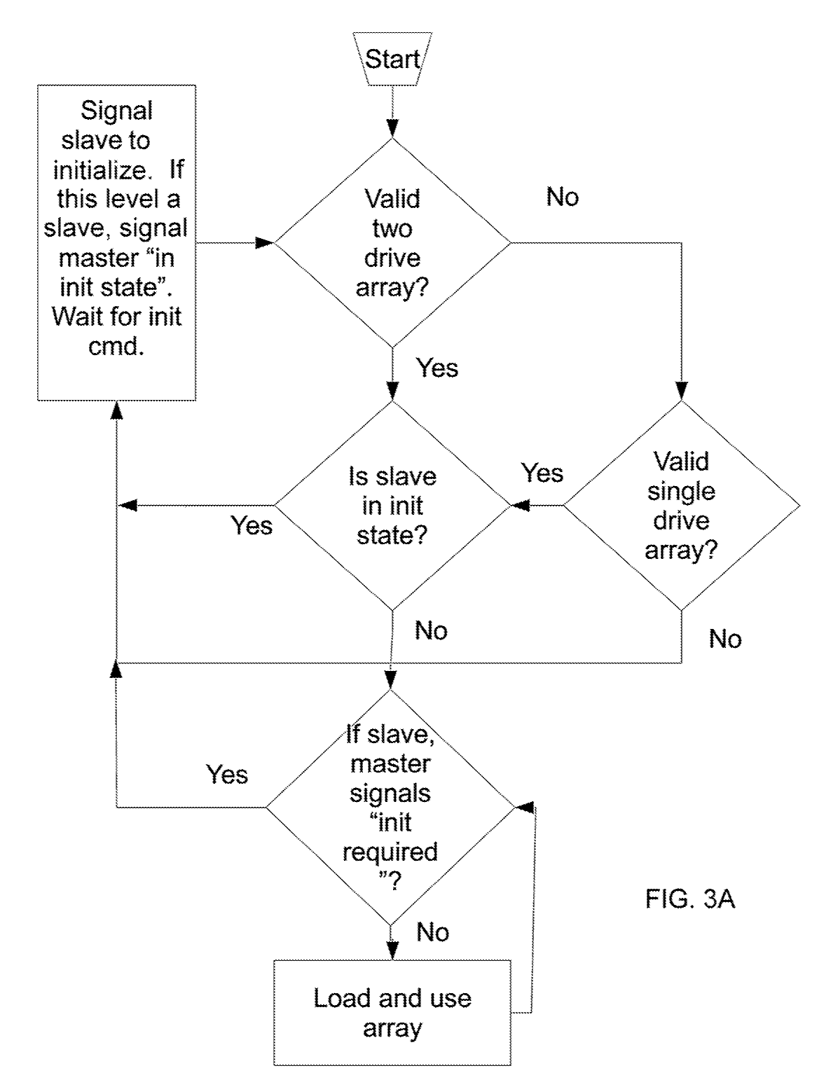

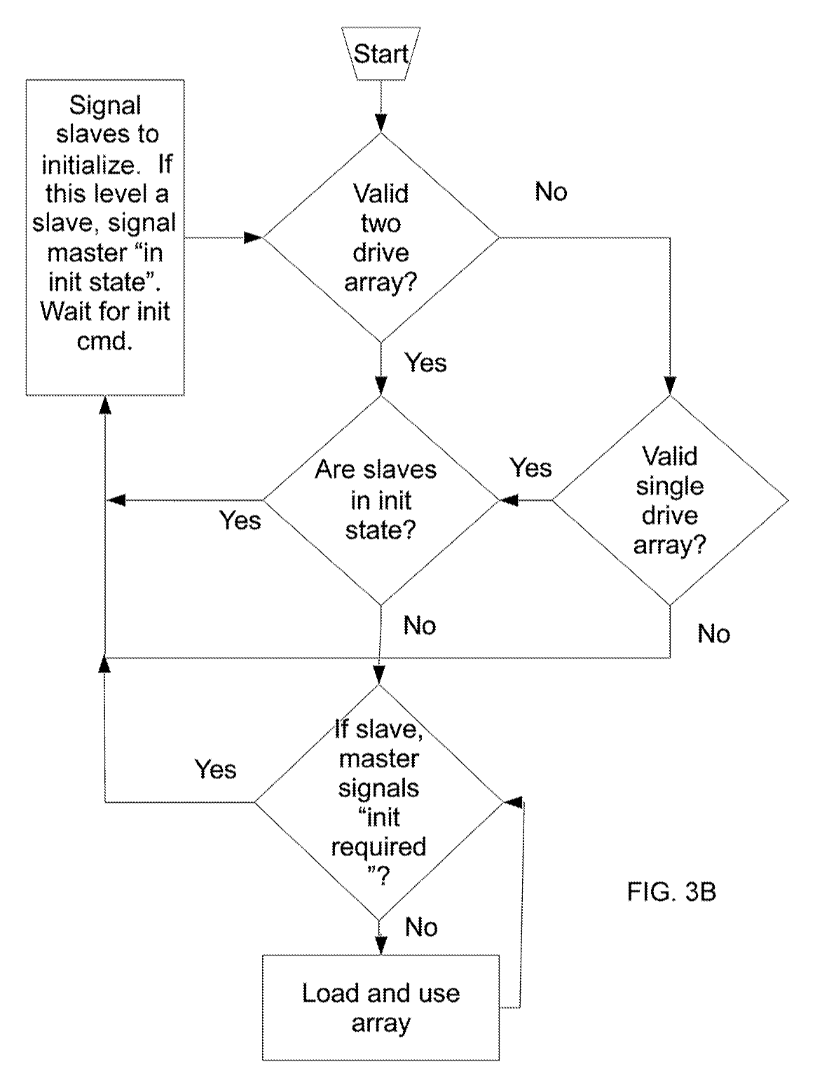

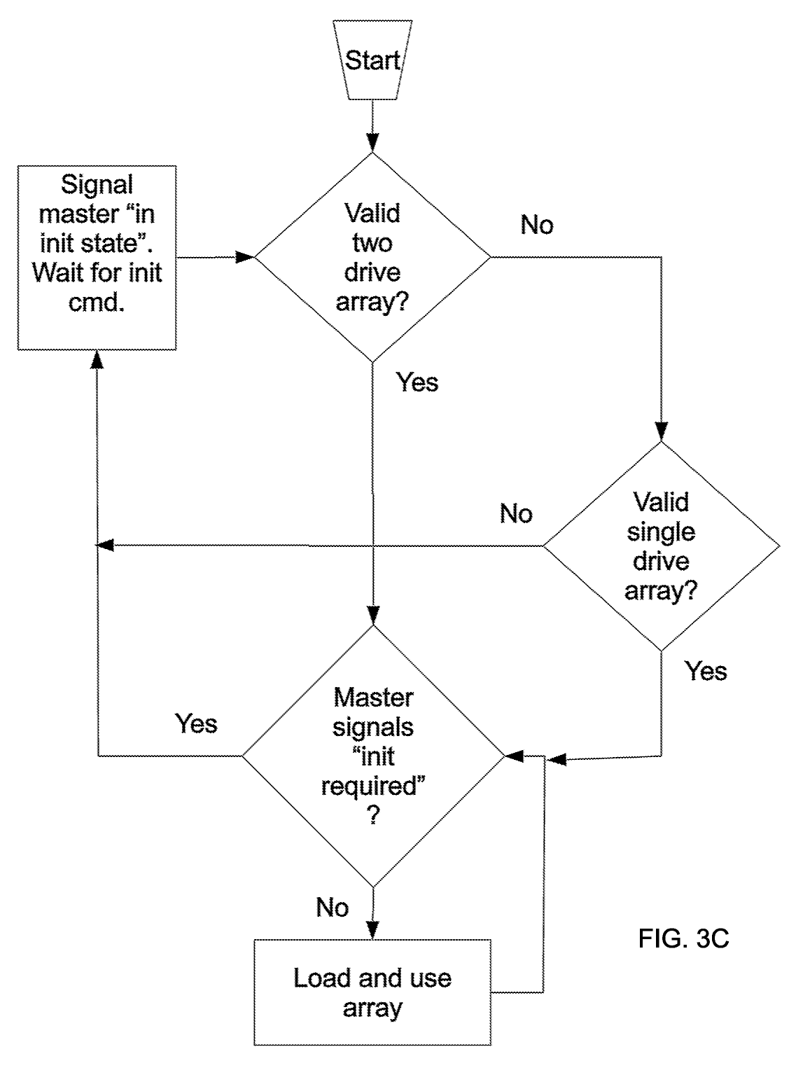

Now turning to the flow chart of FIG. 3A, we describe one embodiment of a process control for a level “L” of a cascaded RAID controller of a cascade RAID 1 controller according to the invention. The process illustrated by the flowchart typically takes place in firmware, at the one level L of the RAID 1 controller. Each RAID 1 level is communicatively coupled with any memory devices and/or virtual memory devices (slaves) at level L+1 as well as with a RAID 1 controller at level L−1.

Turning to FIG. 3A, following a start, such as a power on event, at the “Valid two drive array” query, the level L RAID 1 controller “looks out” from both of its two RAID 1 secondary ports. The level L RAID 1 controller is looking for a valid state store record readable via each of the two secondary ports. If two valid state stores are not yet read, the answer to the “Valid two drive array” is No. There are several reasons why this answer might be No. For example, if there is a hard drive at one of the ports acting as a memory device, the hard drive might not yet have spun-up. During spin-up a state store record on a physical hard drive is not yet readable. If there is a virtual drive on one of the secondary ports, at a level L+1, it might not have yet identified its own state store records on its own two secondary ports yet. With the L+1 level information not yet available, that slave cannot present a valid virtual drive at the current level. For this reason, even though all levels are trying to initialize in parallel, a cascaded RAID controller typically succeeds at each level of initialization from level N towards level 1. For example, if level N has not yet initialized as a valid RAID 1 array, no level above level N can successfully initialize.

If the answer to the next query “Valid single drive array?” (right side of FIG. 3A) is No, a valid state store record was not found on either of the level L secondary ports. In this case of “Valid single drive array?”, answer No, the process continues to the upper left hand side of FIG. 3A, signaling the slave to initialize. Following a determination that further initialization is needed, any suitable timing and/or communication with other levels can be used to go back into the loop for checking for one or both valid state store records at the two secondary ports of the RAID 1 controller at level L. For example, in some embodiments, as indicated on FIG. 3A, level L can also signal all the way back to the master at level 1, indicating that one or more levels are still initializing. In some embodiments, the master level can issue initialization commands to one or more levels, and/or each level can continue to cycle through the secondary port search for store records on its own, according to its own timing.

Whether level L provides its own timing, or waits for the next initialization command from the master (level 1), once the initialization command is provided by the box in the upper left hand corner of FIG. 3A, the query “Valid two drive array” is repeated. On a successive pass through the level L initialization process, there might now be found a valid state store record on one of the level L secondary ports, but not yet at the other level L secondary port. In this case of only one state store record having been found, the “Valid single drive array?” query returns a “Yes”. The “Valid single drive array?”—Yes result then causes the process to ask “is slave in an initialization state?” referring to a slave connected to one of the two secondary ports of the level L controller. If the answer is that the slave in an initialization state, then the process wraps back to the upper left hand corner of FIG. 3A, and following the next initialization command (from the master level and/or the present level), begins the loop anew, with the opening query, is there a “Valid two drive array”. If the answer is No, the slave is not in an initialization state, the process continues down the page on the flow chart of FIG. 3A to the query, “if level L is a slave, is the master (level 1) signaling for an initialization. If the master is signaling for initialization, the process loops again as described hereinabove. If the master is not sending an initialization command, the RAID 1 array at level L is now considered to be “loaded” and ready for use in the cascaded RAID controller. It will be understood to those skilled in the art, that in some embodiments, a cascaded RAID controller process can tolerate one or more missing memory devices which can result in one or more valid operating “single drive” RAID 1 arrays in a cascaded RAID controller apparatus.

The exemplary process flow chart of FIG. 3A can be used with a level L which has one secondary port connected to a memory device and the other secondary port connected a virtual drive, typically another RAID 1 controller at level L+1. Level L can either be at a master level, or at any level L below the master including level N.

The exemplary process flow chart of FIG. 3B can be used with a level L which has both secondary ports connected to a virtual drive, typically two RAID 1 controllers at the level L+1. Level L can either be at a master level, or at any level L below the master including level N.

Another exemplary process flow chart of FIG. 3C is suitable for use with a “slave” or virtual drive, at any level L below a master level 1. The slave has either one secondary port which can be connected to a memory device while the other secondary port is connected a virtual drive, typically another RAID 1 controller at level L+1. In other embodiments, both secondary ports can be connected to a virtual drive, typically two RAID 1 controllers at the level L+1. Level L can be at a master level 1, or at any level L below the master including level N. In the embodiment of FIG. 3C, following a determination of either a valid two drive RAID 1 array or a valid single drive RAID 1 array, the query at the center of the flow chart of FIG. 3A, “is slave in an initialization state?”, can be omitted in the process embodiment of FIG. 3C.

### Hardware

Levels 1 to N of a cascaded RAID controller typically include at least one RAID 1 controller. Each RAID 1 controller can include one or more RAID 1 chips (e.g., a RAID 1 chip set). These RAID 1 controllers can be present in the form of chips mounted on one or more printed circuit boards. For example, the RAID 1 chips or chip sets used at multiple levels, or at all levels, from level 1 to N, can reside on one or more printed circuit boards (PCBs). It is also contemplated that there could be cascaded RAID controller chips or chip sets including multiple RAID 1 controllers disposed within one or more chip packages. A level L (master or slave) RAID 1 controller is communicatively coupled to any slave RAID 1 controllers at level L+1 via the two level L secondary ports. Such communicative coupling between RAID 1 levels can also use any suitable communication technique, such as, for example, a plurality of general purpose input output lines (GPIO) for direct communication between RAID 1 controllers. The level 1 master can communicate with a host apparatus, typically a computer, by any suitable data connection, such as, for example, eSATA, FireWire, or USB. Each level having a secondary port communicatively coupled to a memory device can use any suitable memory device data connection. For example, in some embodiments, an eSATA data connection can be used to communicate with a solid state or spinning hard drive.

### Example

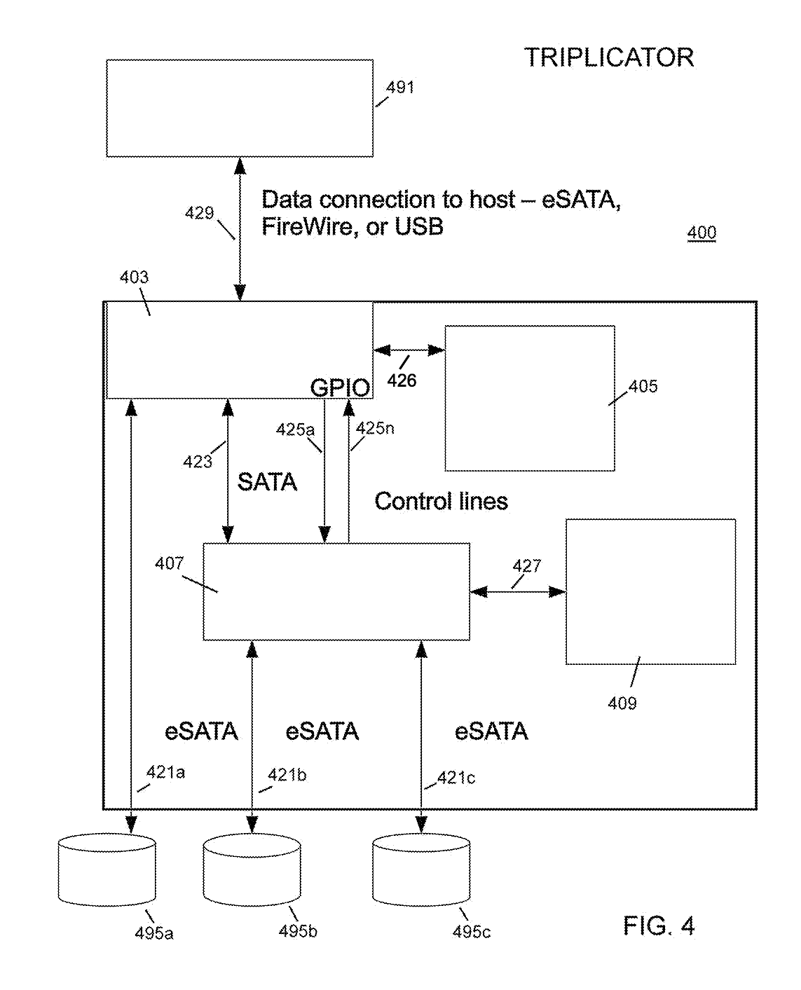

Turning to the block diagram of FIG. 4, we now describe one embodiment of an exemplary cascaded RAID controller in more detail. FIG. 4 shows a block diagram of one exemplary embodiment of a “triplicator” cascaded RAID controller. A triplicator typically presents three memory devices to a host as one cascaded RAID controller or virtual drive. Any data written by a host to the triplicator virtual drive is written identically to all three memory devices. For example, the triplicator virtual drive can be formatted for use with the Microsoft Windows operating system. One or more files can then be written to the triplicator virtual drive, which appears to the host as a single drive device. At the completion of writing the one or more files, there will be three identical copies on the three memory devices. In most embodiments, one or more of the physical memory devices can later be used individually as single memory devices by the same host, or by other hosts, later to read the one or more of the data files previously written to that single memory device by the triplicator apparatus.

Turning back to the block diagram of FIG. 4, the exemplary hardware is now described in more detail. At level 0 (FIG. 1B) there is a host computer 491. Host computer 491 is communicatively connected to the triplicator 400 via data connection 429. In this exemplary embodiment, data connection 429 can be eSATA, FireWire, or USB. In other embodiments, any suitable data connection 429 can be used. Triplicator 400 includes, a first (FIG. 1B, level 1) master RAID 1 controller 403 and a second (FIG. 1B, level 2) slave RAID 1 controller 407. In this FIG. 4 example, RAID 1 controller 403 and a second level 2 slave RAID 1 controller 407 are disposed on a single PCB. The first level 1 master RAID 1 controller 403 and second level 2 slave RAID 1 controller 407 have connections respectively to local memory 405 via a data bus 426 and memory 409 via a data bus 427. Memory 405 and memory 409 operate with RAID 1 controller 403 and a second level 2 slave RAID 1 controller 407 as part of the process control (e.g., as related to firmware). Memories 405 and 409 are distinguished from the RAID 1 “memory devices”, memory devices 495a, 495b, 495c, of the cascaded RAID controller. Triplicator 400 writes and/or reads data from three memory devices 495a, 495b, 495c which are coupled respectively by three eSATA data connections 421a, 421b, and 421c to the RAID 1 controllers 403 and 407.

Each of the three memory devices can have written on them already, or written (e.g., at turn-on) through the initialization process, a state store record as was previously described hereinabove. Once a triplicator 400 successfully initializes as a cascaded RAID controller with three memory devices (e.g., three drives), the virtual drive can be formatted for use with any suitable operating system (e.g., Microsoft Windows). When host 491 writes to the one single triplicator virtual drive, an identical copy of that data is written substantially simultaneously to all three of the memory devices 495a, 495b, 495c (e.g., three hard drives).

Any suitable memory device can be used. In the exemplary triplicator of FIG. 4, the memory devices are most commonly eSATA hard drives or eSATA solid state drives. In other embodiments of cascaded RAID controllers, any suitable type of memory device and any suitable type of data connection can be used. For example, any form of memory card such as including SD memory cards or any form of USB memory can be used as the memory device when a suitable data connection is available that the RAID 1 controller secondary ports.

In one implemented embodiment of the triplicator 400 of FIG. 4, the RAID 1 controllers used were the OXUF936DSE RAID 1 controller chips (available from PLX Technology of Sunnyvale, Calif.) and the memory used (memories 405 and 409) were the SST39VF400A memory chips (available from Silicon Storage Technology of Chandler, Ariz.). Direct communication between the master at level 1 and the slave at level 2 was established using GPIO control lines. Where FireWire is used, for FireWire connectivity, typically another chip is present (not shown in FIG. 4 for simplicity) to provide the physical IEEE-1394 port.

As discussed hereinabove, while less desirable, a cascaded RAID controller can still operate with one or more memory devices absent, as long as at least one memory device present as at least one valid RAID 1 single drive array. Therefore, for example, a triplicator 400 can still function with 1, 2 or 3 memory devices present.

A memory device, once written to by a cascaded RAID controller, can typically be removed and read by the same, or another host computer, as a single physical memory device, without further initialization or formatting (assuming a compatible operating system is used). If the memory device data and store state remain unmodified while that memory device is outside of the cascaded RAID controller which created its store state record, in some embodiments the same memory device can be returned to the same secondary port of the same level from which it was originally removed and it can still initialize using its existing still valid store state.

In a case where a physical memory device is taken from a cascaded RAID controller, modified by some data later written to the same memory device after it was removed from the cascaded RAID apparatus, and then returned to the same cascaded RAID controller, whether or not returned to the same secondary port, it would need to be re-initialized with a new state store record to become a part of a valid RAID 1 array and any pre-existing data on it might be lost and/or overwritten. The same is true for an empty (e.g., new) physical memory device or any other physical memory device which already has some pre-existing data on it. In such cases, in most embodiments, the initialization process of a cascaded RAID controller can prompt a user (typically via a host at level 0) if they agree to destroy any existing data on the physical memory device before proceeding with the level initialization process and writing the new state store record. Where a number of cascaded RAID controllers are in operation, such a user prompt can notify a user that a physical memory device is about to be used in an incorrect cascaded RAID controller (i.e. not the same one it was removed from).

### DEFINITIONS

Recording the results from a write operation, such as for example, writing to a memory device of a cascaded RAID controller, is understood to mean and is defined herein as writing data in a non-transitory manner to a storage element, to a machine-readable storage medium, or to a storage device. Non-transitory machine-readable storage media that can be used in the invention include electronic, magnetic and/or optical storage media, such as magnetic floppy disks and hard disks; a DVD drive, a CD drive that in some embodiments can employ DVD disks, any of CD-ROM disks (i.e., read-only optical storage disks), CD-R disks (i.e., write-once, read-many optical storage disks), and CD-RW disks (i.e., rewriteable optical storage disks); and electronic storage media, such as RAM, ROM, EPROM, Compact Flash cards, PCMCIA cards, or alternatively SD or SDIO memory; and the electronic components (e.g., floppy disk drive, DVD drive, CD/CD-R/CD-RW drive, or Compact Flash/PCMCIA/SD adapter) that accommodate and read from and/or write to the storage media. Unless otherwise explicitly recited, any reference herein to “write”, “writing”, “record” or “recording” is understood to refer to a non-transitory record or a non-transitory recording.

As is known to those of skill in the machine-readable storage media arts, new media and formats for data storage are continually being devised, and any convenient, commercially available storage medium and corresponding read/write device that may become available in the future is likely to be appropriate for use, especially if it provides any of a greater storage capacity, a higher access speed, a smaller size, and a lower cost per bit of stored information. Well known older machine-readable media are also available for use under certain conditions, such as punched paper tape or cards, magnetic recording on tape or wire, optical or magnetic reading of printed characters (e.g., OCR and magnetically encoded symbols) and machine-readable symbols such as one and two dimensional bar codes. Recording data for later use (e.g., writing data to memory or to digital memory) can be performed to enable the use of the recorded information as output, as data for display to a user, or as data to be made available for later use. Such digital memory elements or chips can be standalone memory devices, or can be incorporated within a device of interest. “Writing data” or “writing data to memory” is defined herein as including writing transformed data to registers within a microcomputer.

The RAID 1 controllers of a cascaded RAID controller typically include a microcomputer and/or microcomputer functionality. “Microcomputer” is defined herein as synonymous with microprocessor, microcontroller, and digital signal processor (“DSP”). It is understood that memory used by the microcomputer, including for example instructions for data processing coded as “firmware” can reside in memory physically inside of a RAID 1 controller chip, a microcomputer chip or in memory external to the microcomputer or in a combination of internal and external memory. It is also understood that field programmable array (“FPGA”) chips or application specific integrated circuits (“ASIC”) chips can perform microcomputer functions, either in hardware logic, software emulation of a microcomputer, or by a combination of the two. Apparatus having any of the inventive features described herein can operate entirely on one microcomputer or can include more than one microcomputer.

General purpose programmable computers useful as a host computer for recording data according to the present description can be any of a personal computer (PC), a microprocessor based computer, a portable computer, or other type of processing device. The general purpose programmable computer typically comprises a central processing unit, a storage or memory unit that can record and read information and programs using machine-readable storage media, a communication terminal such as a wired communication device or a wireless communication device, an output device such as a display terminal, and an input device such as a keyboard. The display terminal can be a touch screen display, in which case it can function as both a display device and an input device. Different and/or additional input devices can be present such as a pointing device, such as a mouse or a joystick, and different or additional output devices can be present such as an enunciator, for example a speaker, a second display, or a printer. The computer can run any one of a variety of operating systems, such as for example, any one of several versions of Windows, or of MacOS, or of UNIX, or of Linux. Computational results obtained in the operation of the general purpose computer can be stored for later use, and/or can be displayed to a user. At the very least, each microprocessor-based general purpose computer has registers that store the results of each computational step within the microprocessor, which results are then commonly stored in cache memory for later use.

Many functions of electrical and electronic controller can be implemented in hardware (for example, hard-wired logic), in software (for example, logic encoded in a program operating on a general purpose processor), and in firmware (for example, logic encoded in a non-volatile memory that is invoked for operation on a processor as required). The present invention contemplates the substitution of one implementation of hardware, firmware and software for another implementation of the equivalent functionality using a different one of hardware, firmware and software. To the extent that an implementation can be represented mathematically by a transfer function, that is, a specified response is generated at an output terminal for a specific excitation applied to an input terminal of a “black box” exhibiting the transfer function, any implementation of the transfer function, including any combination of hardware, firmware and software implementations of portions or segments of the transfer function, is contemplated herein, so long as at least some of the implementation is performed in hardware.

Any patent, patent application, or publication identified in the specification is hereby incorporated by reference herein in its entirety. Any material, or portion thereof, that is said to be incorporated by reference herein, but which conflicts with existing definitions, statements, or other disclosure material explicitly set forth herein is only incorporated to the extent that no conflict arises between that incorporated material and the present disclosure material. In the event of a conflict, the conflict is to be resolved in favor of the present disclosure as the preferred disclosure.

While the present invention has been particularly shown and described with reference to the preferred mode as illustrated in the drawing, it will be understood by one skilled in the art that various changes in detail may be affected therein without departing from the spirit and scope of the invention as defined by the claims.

What is claimed is:

1. A cascaded RAID controller, comprising:
a master RAID 1 controller having a control level and M slave RAID 1 controllers each having a lower control level than said control level of said master RAID 1 controller, where M is an integer greater than or equal to 1, each of said M+1 RAID 1 controllers configured respectively to have three ports, including a primary port configured to communicate bi-directionally with computer hardware having a higher control level than that of said respective one of said M+1 RAID 1 controllers and including two secondary ports, each secondary port configured to communicate bi-directionally with computer hardware having a lower control level than that of said respective one of said M+1 RAID 1 controllers, each one of said M+1 RAID 1 controllers having a direct communication connection to at least one other RAID 1 controller of said M+1 RAID 1 controllers;
said master RAID 1 controller configured to be connected to a host computer having a highest control level via said primary port of said master RAID 1 controller;
each of said otherwise unconnected secondary ports of said M+1 RAID 1 controllers configured to be communicatively connected bi-directionally to a memory device configured to record information;
at least one of said M slave controllers configured to determine whether two memory devices connected to said secondary ports of said at least one of said M slave controllers are configured as a duplicate RAID 1 memory; and
said master RAID 1 controller configured to determine whether said two memory devices connected to said secondary ports of said at least one of said M slave controllers and another memory device connected to a respective one of said secondary ports of another of said M+1 RAID 1 controllers are configured as a triplicate RAID 1 memory;
said cascaded RAID controller configured to provide connections to a total of M+2 memory devices, and configured to record the same information on each of said M+2 memory devices to create M+2 identical copies of said information.

2. The cascaded RAID controller of claim 1, wherein, said primary port of said master RAID 1 controller is configured to communicate bi-directionally with computer hardware comprises an eSATA data connection.

3. The cascaded RAID controller of claim 1, wherein, said primary port of said master RAID 1 controller is configured to communicate bi-directionally with computer hardware comprises a FireWire data connection.

4. The cascaded RAID controller of claim 1, wherein, said primary port of said master RAID 1 controller is configured to communicate bi-directionally with computer hardware comprises a USB data connection.

5. The cascaded RAID controller of claim 1, wherein, said direct communication connection comprises a selected one of a plurality of general purpose I/O (GPIO) lines, SATA, and eSATA.

6. The cascaded RAID controller of claim 1, wherein, a RAID 1 controller at a level L communicates to a RAID 1 controller at a level L−1 a status indicative of whether a state store record is found on either of its own said two secondary ports via said direct communication connection.

7. The cascaded RAID controller of claim 1, where M=1 and said cascaded RAID controller is configured as a triplicator.

8. A process for initializing a cascaded RAID controller comprising the steps of:
providing a cascaded RAID controller comprising a master RAID 1 controller having a control level and M slave RAID 1 controllers each having a lower control level than said control level of said master RAID 1 controller, where M is an integer greater than or equal to 1, each one of said M+1 RAID 1 controllers having a direct communication connection to at least one other RAID 1 controller of said M+1 RAID 1 controllers;
running an initialization process simultaneously on said M+1 RAID 1 controllers to check for a valid RAID 1 array;
communicating a status of a valid RAID 1 array from each of said M+1 RAID 1 controllers at a level L to a RAID 1 controller at a level L−1 ;
loading each of said RAID 1 controllers when all RAID 1 controllers at one or more levels below said level L of each RAID 1 controller have indicated a presence of a valid RAID 1 array; and
presenting a virtual memory device at a primary port of said master RAID 1 controller.

9. The process for initializing a cascaded RAID controller of claim 8, wherein said step of presenting a virtual memory device comprises the step of presenting a virtual memory device at a primary port of said master RAID 1 controller, wherein said virtual memory device comprises a total of up to M+2 memory devices.

10. The process for initializing a cascaded RAID controller of claim 8, wherein said step of running an initialization process simultaneously on said M+1 RAID 1 controllers comprises checking for a presence of and reading a state store record on both secondary ports of each of said M+1 RAID 1 controllers.
